(19) United States
(12) Patent Application Publication
(10) Pub. No.: US 2023/0007848 A1
(43) Pub. Date: Jan. 12, 2023

(54) Air Brake System Having an Improved Anti-Compounding Function

(71) Applicant: Bendix Commercial Vehicle Systems LLC, Elyira, OH (US)

(72) Inventor: David W. HOWELL, Elyira, OH (US)

(21) Appl. No.: 17/372,104

(22) Filed: Jul. 9, 2021

(51) Int. Cl. B60T 17/08; B60T 13/38; B60T 15/36; F16D 65/28

(52) U.S. Cl. CPC B60T 17/083; B60T 13/38; B60T 15/36; F16D 65/28; F16D 2125/08

(57) ABSTRACT

A spring brake system includes a service brake chamber, a spring brake chamber adjacent to the service brake chamber, a wall separating the service brake chamber from the spring brake chamber, a shaft, and a device. The shaft extends from the service brake chamber into the spring brake chamber through an opening in the wall. The device is disposed along the shaft through the wall, the device being configured to: i) allow air to flow from the service chamber into the spring brake chamber, and ii) prevent air from flowing from the spring brake chamber into the service chamber. The air is within a range that is sufficient to reduce a pressure differential between the service brake chamber and the spring brake chamber. The air is also within a range that is sufficient to generate an anti-compounding effect.

### FIELD OF ENDEAVOR

The field of endeavor of the present disclosure is that of anti-compounding air brake systems. That is, the field of endeavor is not just that of air brake systems. But rather, that of air brake systems having an anti-compounding function.

### BACKGROUND

Commercial vehicles are generally equipped with air brake systems. In these air brake systems, the problem of compounding may arise when the vehicle's parking brake has been applied, and while the vehicle's parking brake is on, an operator also applies the service brake. Parking brakes are engaged by exhausting air pressure allowing powerful springs to engage the brakes to hold the vehicle stationary. Air pressure is applied when the operator wants to disengage the springs and release the parking brakes. Service brakes are applied directly by air pressure, the inverse of parking brakes. That is how applying pressure can both engage service brakes and disengage parking brakes at the same time.

This compounding force can have detrimental effects on air brake systems, including eventual damage. One way to address compounding is to equip air brake systems with anti-compounding devices. Anti-compounding valves permit service brake pressure to also flow into the parking brake system to release the parking brakes as the service brakes are applied, which would not happen if the two circuits were mutually isolated without these valves. This invention provides another supplemental path for air to flow from the service brakes into the parking brakes, but prohibits flow in the opposite direction from parking to service.

In addition, typical air brake systems are equipped with an o-ring at the interface between the service brake chamber and the spring brake chamber. These O-rings experience friction during operation of the air brake system, as the actuating shaft slides through the O-ring. This friction impacts the service life of the existing air brake chambers.

### SUMMARY

Currently there exists no brake system that is capable of both augmenting and/or speeding up the anti-compounding function, while at the same time reducing friction at the interface between the service brake chamber and the spring brake chamber.

In light of the above, this disclosure is reasonably pertinent to the problems of: augmenting and/or speeding up an anti-compounding function in air brake systems, and reducing friction at an interface between service brake chamber and the spring brake chamber.

The above-referenced problems are solved by the inventive air brake system disclosed in this specification. In particular, the above-referenced problem is solved by an air brake system having a service brake chamber, a spring brake chamber adjacent to the service brake chamber, a wall separating the service brake chamber from the spring brake chamber, a shaft, and a device. The shaft extends from the service brake chamber into the spring brake chamber through an opening in the wall. The device is disposed in the opening and is configured to: i) allow air to flow from the service chamber into the spring brake chamber, and ii) prevent any air from flowing from the spring brake chamber into the service brake chamber. The air is within a range that is sufficient to reduce a pressure differential between the service brake chamber and the spring brake chamber. The air is also within a range that is sufficient to generate an anti-compounding effect.

With the foregoing configuration, the inventive air brake system solves the problem of augmenting and/or speeding up the anti-compounding function (in some embodiments in conjunction with an anti-compounding valve) because the inventive air brake system allows air to flow from the service brake chamber into the spring brake chamber. This function by itself yields a stand-alone anti-compounding function, and when the air brake system is equipped with an external or separate anti-compounding device, the inventive air brake system augments that external anti-compounding function. Further, this contribution/argumentation also results in faster overall response time of the anti-compounding function.

The inventive air brake system, however, does not only provide a solution to the above-referenced problems, but in addition the inventive air brake system exhibits a number of substantially improved results over existing air brake systems.

For example, the inventive air brake system augments and speeds up the anti-compounding function without relying on larger or additional air valves. These larger or additional air valves are also far costlier than the solution provided in this disclosure. Consequently, the inventive air brake system is easier and less expensive to manufacture.

The inventive air brake system also exhibits improved service life. In fact, because the inventive air brake system lacks an O-ring, and in its place uses a U-cup seal, the inventive air brake system reduces friction, and thereby improves performance and service life.

The inventive air brake system also greatly improves response time. For instance, in conventional air brake systems the anti-compounding function is carried out using costly relay valves to improve speed, without which the system is slow to respond. In stark contrast to conventional air brake systems, the inventive air brake system disclosed herein provides a significant degree of anti-compounding with a rapid response time.

Other objects, advantages and novel features of the present invention will become apparent from the following detailed description of one or more preferred embodiments when considered in conjunction with the accompanying drawings, in which:

### BRIEF DESCRIPTION OF THE DRAWINGS

FIG. 1 is a diagram of an inventive air brake system;

FIGS. 2A-2C are perspective views of a sealing device;

FIG. 3 is a diagram of an inventive air brake system;

FIG. 4 is a flowchart of the inventive method; and

FIG. 5 is a diagram of an inventive air brake system;

### DETAILED DESCRIPTION

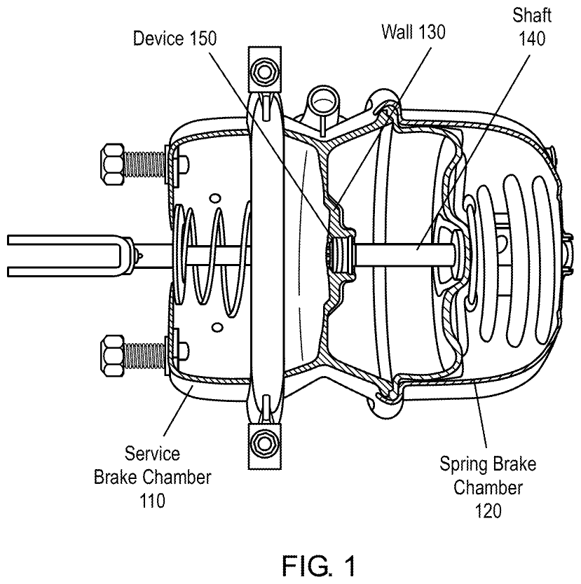

With reference to FIG. 1, the inventive spring brake system 100 includes, inter alia, a service brake chamber 110, a spring brake chamber 120, a wall 130, a shaft 140, and a device 150. As can be seen in FIG. 1, the service brake chamber 110 is disposed in such a manner so as to be adjacent to the spring brake chamber 120. Interposed between the service brake chamber 110 and the spring brake chamber 120 there is a wall 130, which separates the service brake chamber 110 from the spring brake chamber 120, so that these two chambers are constituted as two individual chambers.

As shown in FIG. 1, the inventive spring brake system 100 also includes a shaft 140, which extends from the service brake chamber 110 into the spring brake chamber 120 through an opening in the wall 130. Disposed on the shaft 140 there is a device 150, the device is disposed in the opening that is formed on the wall 130. That is, the device 150 is disposed on the shaft where it is configured to allow air to flow from the service brake chamber 110 into the spring brake chamber 120, while preventing any air from flowing from the spring brake chamber 120 into the service chamber 110. In other words, the device 150 allows air to flow in a single direction, and more specifically, the device 150 allows air to flow only from the service chamber 110 into the spring brake chamber 120.

The air that flows from the service chamber 110 into the spring brake chamber 120 is limited. That is, in the inventive air brake system 100 the air is not allowed to flow freely from the service brake chamber 110 into the spring brake chamber 120. Rather, the air flowing from the service brake chamber 110 into the spring brake chamber 120 is within a range that is sufficient to generate an anti-compounding effect, while reducing a pressure differential between the service brake chamber 110 and the spring brake chamber 120. Further, as can be seen in FIG. 1, the device 150 is disposed at the opening of the wall 130 in such away so as to circumferentially surround the shaft 140

With the above configuration, the inventive brake system 100 blocks air flow from the spring brake chamber 120 into the service brake chamber 110, while at the same time allowing one-way flow of air from the service brake chamber 110 into the spring brake chamber 120, to thereby enhance an anti-compounding effect.

In addition, as can be seen in FIG. 1, the device 150 is disposed on the wall 130 so as to cooperate directly with shaft 140. In other words, as the shaft 140 is actuated, the shaft engages with the device 150 at a location of the brake system 100 where in a conventional brake system (not shown) there is installed an O-ring. That is, in a conventional air brake system, an O-ring is disposed at the location where the device 150 is disposed in the inventive air brake system 100. In the conventional air brake system, this O-ring is used in an effort to prevent the flow of air between the service brake chamber 110 and the spring brake chamber 120, and vice versa. Thus, in the conventional air brake system (not shown), the O-ring is exposed to not only the friction generated by the sliding action of the shaft against the O-ring, but at the same time the O-ring is also submitted to internal pressures, as the O-ring prevents all air flow. As a result of the foregoing, in a conventional air brake system, this excess friction and pressures can cause the O-ring to fail.

In the inventive air brake system 100, however, the device 150 blocks air flow from the spring brake chamber 120 into the service brake chamber 110, while at the same time allowing one-way flow of air from the service brake chamber 110 into the spring brake chamber 120. As a direct result of these features, the inventive air brake system 100 not only enhances and speeds up an anti-compounding effect, but the inventive air brake system 100 also reduces the friction to which the device 150 is subjected, thereby improving the service life of the air brake system 100.

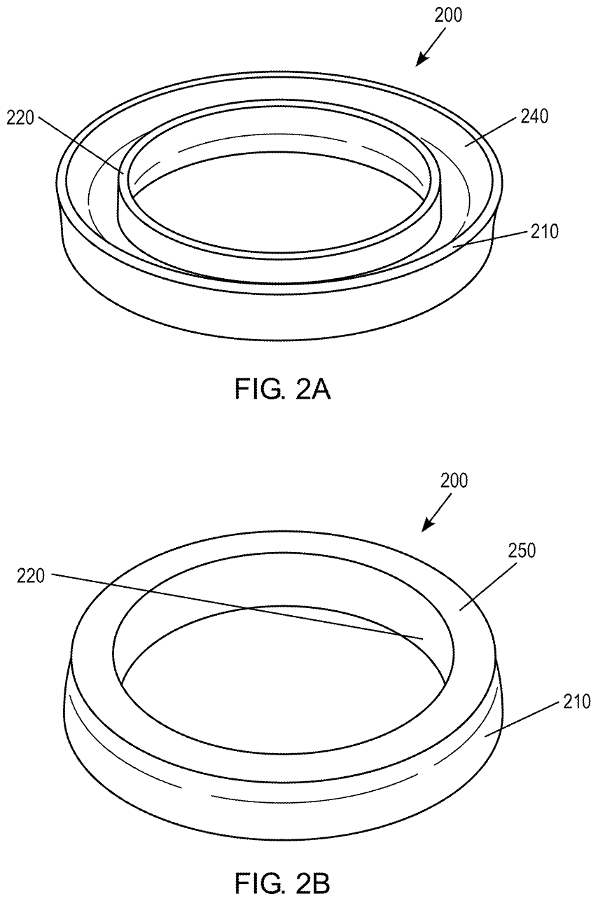

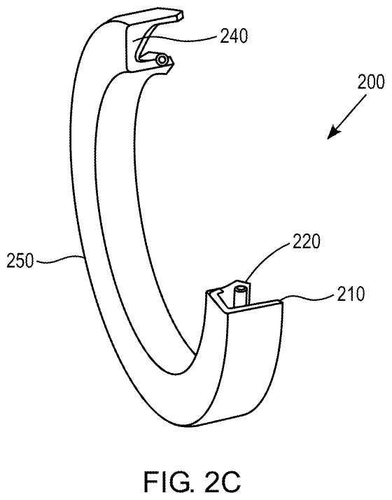

In some embodiments, the device 150 may be a one-way seal. For instance, in some embodiments, with reference to FIGS. 2A and 2B, the device 150 may be a U-cup seal 200 having an outer circumferential sealing surface 210 and an inner circumferential sealing surface 220. The inventive air brake system 100, however, need not be limited to such configuration. For instance, in other embodiments the device 150 may be a V-cup seal (not shown), or any other kind of seal that may occur to those having ordinary skill in the art, as long as the device 150 has an open end 240 and a closed end 250. As can be seen in FIGS. 2A and 2B, the open end 240 may indeed have a U-shape. In other embodiments, however, the open end may also have a V-shape, a rectangular shape, a quadrangular or any other shape as may occur to those having ordinary skill in the art, as long as the open end 240 faces the side from which to prevent air flow. Thus, in the embodiment of FIG. 1, the open end 240 faces the spring brake chamber 120 while the closed end 250 faces the service brake chamber 110 thereby preventing air flow from the spring brake chamber 120 to the service brake chamber 110.

As shown in FIGS. 2A, 2B, and 2C, the U-cup seal 200 has an outer circumferential sealing surface 210 and an inner circumferential sealing surface 220. Further, the outer circumferential sealing surface 210 forms a seal between the device 150 and the wall 130 of FIG. 1. That is, the U-cup seal 200 is inserted into an opening formed in the wall 130 in such a way that the outer circumferential sealing surface 210 contacts the wall 130. Further, the inner circumferential sealing surface 220 forms a seal between the device 150 and the shaft 140. With this configuration, the inventive U-cup seal 200 effectively replaces the o-ring that is found in conventional air brake systems.

Notably, the inventive air brake system 100 is configured in such a way that air flows through the inner circumferential sealing surface 220. That is, air is allowed to flow through the seal that is formed between the inner circumferential sealing surface 220 and the shaft 140. The inventive air brake system 100, however, need not be limited to such configuration. For instance, in other configurations the inventive air brake system 100 may be configured in such a way that air also flows through the seal formed between the outer circumferential sealing surface 210 and the wall 130. That is, in other embodiments, the inventive air brake system 100 may allow air to flow through both the outer circumferential sealing surface 210 and the inner circumferential sealing surface 220. Alternatively, the air may flow only through one of these sealing surfaces.

Likewise, in the inventive air brake system 100, the air may not be allowed to flow freely. Rather, in other configurations the inventive air brake system 100 may be configured such that the air flows through the inner circumferential sealing surface 220 only when a pressure in the service brake chamber 110 is higher than the pressure in the spring brake chamber 120 by a given pressure threshold.

The given pressure threshold is selected to control air flowing from the service brake chamber 110 into the spring brake chamber 120. That is, it should be understood to those having ordinary skill in the art, that the inventive air brake system 100 is not limited to any particular disclosed pressure threshold. Instead, the inventive air brake system 100 will achieve its intended purpose when the pressure threshold is such that it causes excess pressure in the service brake chamber 110 to flow into the spring brake chamber 120. Thus, the pressure threshold can be set to any range that may occur to those having ordinary skill in the art.

With the above configuration, the inventive air brake system 100 provides a highly effective and fast acting anti-compounding effect by allowing pressure in the service brake chamber 110 to flow into the spring brake chamber 120, via an existing structure (e.g., opening in the wall 130), which has previously been conventionally sealed with an O-ring that prevented any air flow. Thus, in addition to the various benefits previously discussed, the inventive air brake system 100 can be realized without requiring substantial modification to air brake components.

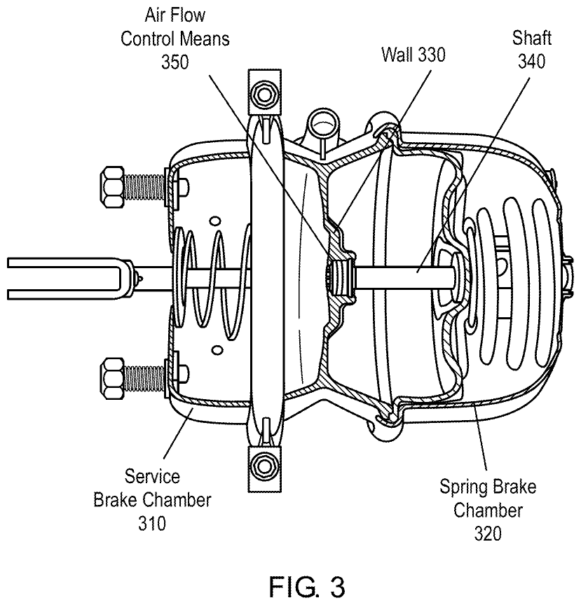

With reference to FIG. 3, an inventive air brake system 300 includes a service brake chamber 310, a spring brake chamber 320, a wall 330, a shaft 340, and air flow control means 350. The spring brake chamber 320 is disposed adjacent the service brake chamber 310. The wall 330 separates the service brake chamber 310 from the spring brake chamber 320. The shaft 340 extends from the service brake chamber 310 into the spring brake chamber 320 through an opening in the wall 330. The flow control means 350 allows air to flow from the service chamber 310 into the spring brake chamber 320. Notably, the air is within a range that is sufficient to generate an anti-compounding effect and reduce a pressure differential between the service brake chamber 310 and the spring brake chamber 320. The air flow control means 350 is disposed at the opening in the wall 330 in such away so as to surround the shaft 340.

With the above configuration, the inventive air brake system 300 not only achieves an anti-compounding effect, but does so in an efficient and rapid fashion. Additionally, the inventive air brake system 300 reduces friction, and therefore improves service life.

The air flow control means 350 may be a one-way seal. For example, the air flow control means 350 may be a U-cup seal 200 having outer circumferential sealing surface 210 and an inner circumferential sealing surface 220. As was previously disclosed, the inventive air brake system 300 need not be limited to such configuration. Thus, the air flow control means 350 may be of any type as may occur to those of ordinary skill in the art, including, for example, a V-shape seal, a rectangular shape seal, a quadrangular shape seal, or any other shape as may occur to those having ordinary skill in the art. For instance, as shown in Figure two, in a U-cup seal 200 configuration, the open end 240 may be U-shaped, while the closed end 250 may be substantially planar.

As with the previous embodiment, the inventive air brake system 300 is configured in such a way that air is allowed to flow through the seal that is formed between the inner circumferential sealing surface (320 is spring brake chamber?) and the shaft (340?). The inventive air brake system 300, however, need not be limited to such configuration. For instance, in other configurations the inventive air brake system 300 may be configured in such a way that air also flows through the seal formed between the outer circumferential sealing surface (310 is service brake chamber?) and the wall 130. That is, in other embodiments, the inventive air brake system 300 may allow air to flow through both the outer circumferential sealing surface (?) and the inner circumferential sealing surface (?). Alternatively, the air may flow only through one of these sealing surfaces.

It should be noted, however, that the inventive air brake system 300 is configured such that the air flows through the inner circumferential sealing surface (?) only when a pressure in the service brake chamber 310 is higher than in the spring brake chamber plus a given pressure threshold.

The given pressure threshold is a pressure differential that will cause air to flow from the service brake chamber 310 into the spring brake chamber 320. That is, it should be understood to those of ordinary skill in the art, that the inventive brake system 300 is not limited to any particular disclosed pressure threshold or range. Thus, the pressure threshold can be set to be any range that may occur to those having ordinary skill in the art, so long as the pressure threshold causes air to flow from the service brake chamber 310 into the spring brake chamber 320.

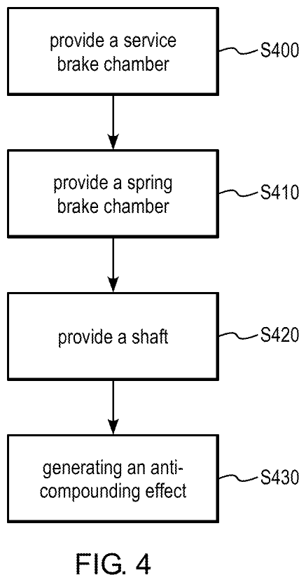

In a further development, this disclosure is also directed to a method for generating an anti-compounding effect in a brake system. With reference to FIG. 4, the method includes providing a service brake chamber S400. In step S410 the inventive method includes providing a spring brake chamber that is disposed adjacent the service brake chamber, the service brake chamber being separated from the spring brake chamber by a wall. In step S420, the inventive method includes providing a shaft that extends from the service brake chamber into the spring brake chamber through an opening in the wall. In step S430, the inventive method includes generating an anti-compounding effect.

Notably, this anti-compounding effect is generated by causing air to flow through the opening and around the shaft. This is a radical departure from conventional methods for generating anti-compounding in air brake systems, in which the air flow is directed via additional air valves, and in which the opening and the space around the shaft is actually sealed by an O-ring, which is used to actually prevent any air flow.

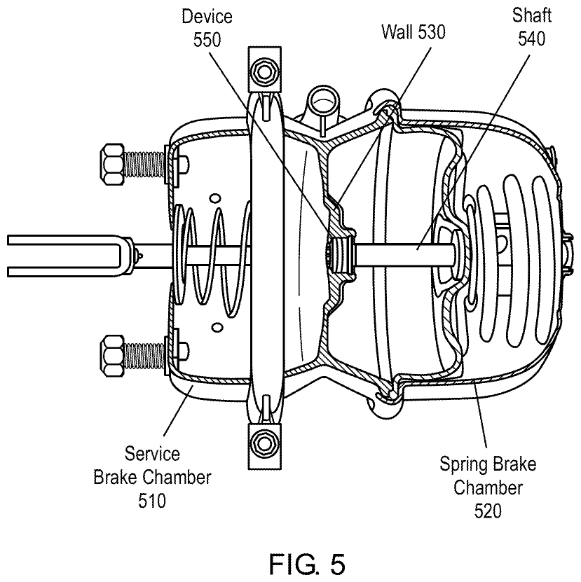

With reference to FIG. 5, in the inventive method the anti-compounding effect is generated by causing air to flow through an opening in a wall 530 that separates the service brake chamber 510 from the spring brake chamber 520. Notably, in the inventive method a device 550 is disposed around the shaft 540. The device 550 allows air to flow from the service brake chamber 510 into the spring brake chamber 520. Further, the device 550 also prevents any air from flowing from the spring brake chamber 520 into the service brake chamber 510.

In order to achieve this anti-compounding effect, the device 550 forms a seal between the wall 530 and the shaft 540. However, once the air pressure reaches a certain range, the device 550 allows air to flow from the service chamber 510 through the device 550, around the shaft 540, and into the spring brake chamber 520. That is from left to right in FIG. 5. The device 550, however, does not allow air to flow in the opposite direction. That is, the device 550 prevents any air from flowing from the spring brake chamber 520 into the service chamber 510.

The air pressure range that causes the above-discussed motion need not be limited to any particular range or even single value. In fact, the pressure range may be any value or range that may occur to those having ordinary skill in the art, as long as the pressure range is sufficient to generate an anti-compounding effect, and reduce a pressure differential between the service brake chamber 510 and the spring brake chamber 520. In other words, when a pressure in the service brake chamber 510 begins to increase and approaches a level of compounding that is undesirable, in the inventive method the device 550 will allow this excess pressure to flow into the spring brake chamber 520.

In one embodiment, such as that shown in FIGS. 2A and 2B, the device 550 may be a U-cup seal 200 having an outer circumferential sealing surface 210, and an inner circumferential sealing surface 220. The device 550, however, need not be limited to such configuration. In fact, in other embodiments that device 550 may be any type of one-way seal as may occur to those having ordinary skill in the art, including, for example, a V-shape seal, a rectangular shape seal, a quadrangular shape seal, or any other shape as may occur to those having ordinary skill in the art.

As in the previous embodiment, the U-cup seal 200 outer circumferential sealing surface 210 forms a seal with the wall 530, and the inner circumferential sealing surface 220 forms a seal with the shaft 540. In one embodiment the air is allowed to flow through the seal with the shaft 540. However, as was previously noted, in the inventive method the air flow may: alternatively flow through the seal with the wall 530, or additionally flow through the seal with the wall 530.

Further, various characteristics of the inner circumferential sealing surface 220 can be selectively modified to achieve a desired pressure response including a thickness, material composition, and a geometry thereof. In addition, the inner circumferential sealing surface 220 can also include a pressure ring (not shown) which strengthens the integrity of the seal against the shaft 540. Further, the pressure ring can itself be modified in terms of thickness, material composition, and geometry thereof. Moreover, these modifications can be made individually, or they can include a number of them at the same time. For instance, only the thickness, or the material composition, and or the geometry of the inner circumferential sealing surface 220 may be modified, or a number of these properties, or even all of these properties may be modified at the same time. Further, as an alternative or in addition thereto, a pressure ring may be added to the seal 200. Additionally, the thickness, material composition, and geometry of the seal ring can also be modified individually or collectively. In fact, a person having ordinary skill in the art should understand that any number of these modifications could be made to achieve a desired pressure response. Meaning, these characteristics can be modified so as to cause the seal formed by the inner circumferential sealing surface 220 against shaft 540 to allow air to flow at a given or desired pressure, but not below that given or desired pressure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An air brake system comprising:
a service brake chamber;
a spring brake chamber that is disposed adjacent to the service brake chamber;
a wall that separates the service brake chamber from the spring brake chamber;
a shaft that extends from the service brake chamber into the spring brake chamber through an opening in the wall;
a device that is disposed in the opening so as to surround the shaft, the device being configured to: i) allow air to flow from the service chamber into the spring brake chamber, and ii) prevent air from flowing from the spring brake chamber into the service brake chamber, wherein
the air is within a range that is sufficient to: i) reduce a pressure differential between the service brake chamber and the spring brake chamber, and ii) generate an anti-compounding effect.

2. The air brake system according to claim 1, wherein the device is a one-way seal.

3. The air brake system according to claim 2, wherein the one-way seal is a U-cup seal having outer circumferential sealing surface and an inner circumferential sealing surface.

4. The air brake system according to claim 3, wherein the outer circumferential sealing surface forms a seal between the device and the wall, and the inner circumferential sealing surface forms a seal between the device and the shaft.

5. The air brake system according to claim 4, wherein the air is configured to flow through the seal between the device and the shaft.

6. The air brake system according to claim 5, wherein the air is configured to flow through the seal between the device and the shaft only when a pressure in the service chamber is higher than a given pressure threshold.

7. The air brake system according to claim 6, wherein the given pressure threshold is also higher than a pressure in the spring brake chamber.

8. An air brake system comprising:
a service brake chamber;
a spring brake chamber disposed adjacent to the service brake chamber;
a wall that separates the service brake chamber from the spring brake chamber;
a shaft that extends from the service brake chamber into the spring brake chamber through an opening in the wall;
air flow control means for allowing air to flow from the service chamber into the spring brake chamber, wherein
the air is within a range that is sufficient to: i) generate an anti-compounding effect, and ii) reduce a pressure differential between the service brake chamber and the spring brake chamber, and
the airflow control means is disposed in the opening in such away so as to surround the shaft.

9. The air brake system according to claim 8, wherein the device is a one-way seal.

10. The air brake system according to claim 9, wherein the one-way seal is a U-cup seal having outer circumferential sealing surface and an inner circumferential sealing surface.

11. The air brake system according to claim 10, wherein the outer circumferential sealing surface forms a seal between the U-cup seal and the wall, and the inner circumferential sealing surface forms a seal between the U-cup seal and the shaft.

12. The air brake system according to claim 11, wherein the air is configured to flow through the seal between the U-cup seal and the shaft.

13. The air brake system according to claim 11, wherein the air is configured to flow through the seal between the U-cup seal and the shaft only when a pressure in the service chamber is higher than a given pressure threshold.

14. The air brake system according to claim 13, wherein the given pressure threshold is also higher than a pressure in the spring brake chamber.

15. A method for generating an anti-compounding effect in an air brake system, comprising:
providing a service brake chamber;
providing a spring brake chamber that is disposed adjacent the service brake chamber, the service brake chamber being separated from the spring brake chamber by a wall;
providing a shaft that extends from the service brake chamber into the spring brake chamber through an opening in the wall; and
generating an anti-compounding effect by placing a device in the opening of the wall which allows air to flow through the opening and around the shaft.

16. The method according to claim 15, wherein
the device is configured to: i) allow air to flow from the service brake chamber into the spring brake chamber, and ii) prevent any air from flowing from the spring brake chamber into the service brake chamber, wherein
the air is within a range that is sufficient to: i) generate an anti-compounding effect, and ii) reduce a pressure differential between the service brake chamber and the spring brake chamber, and
the device is disposed at the opening in the wall in such away so as to surround the shaft.

17. The method according to claim 16, wherein the seal is a U-cup seal having outer circumferential sealing surface and an inner circumferential sealing surface.

18. The method according to claim 17, wherein the outer circumferential sealing surface forms a seal between the U-cup seal and the wall, and the inner circumferential sealing surface forms a seal between the U-cup seal and the shaft.

19. The method according to claim 18, wherein the air is configured to flow through the seal between the U-cup seal and the shaft.

20. The method according to claim 19, wherein the air is configured to flow through the seal between the U-cup seal and the shaft only when a pressure in the service chamber is higher than a given pressure threshold and the given pressure threshold is also higher than a pressure in the spring brake chamber.
